(19) United States
(12) Patent Application Publication
(10) Pub. No.: US 2019/0051164 A1
(43) Pub. Date: Feb. 14, 2019

(54) SYSTEM AND METHOD FOR RETAIL REVENUE BASED TRAFFIC MANAGEMENT

(71) Applicant: GRIDSMART Technologies, Inc., Knoxville, TN (US)

(72) Inventors: William A. Malkes, Knoxville, TN (US); William S. Overstreet, Knoxville, TN (US); Jeffery R. Price, Knoxville, TN (US); Michael J. Tourville, Knoxville, TN (US)

(21) Appl. No.: 16/101,766

(22) Filed: Aug. 13, 2018

Related U.S. Application Data
(60) Provisional application No. 62/545,289, filed on Aug. 14, 2017.

(51) Int. Cl. G08G 1/01; G06Q 30/02; G08G 1/07; G06F 17/30; G06F 17/15

(52) U.S. Cl. CPC G08G 1/0145; G06Q 30/0201; G06F 17/15; G06F 17/30964; G08G 1/07

(57) ABSTRACT

A traffic control system and a method for retail revenue based traffic management are disclosed. One aspect of the present disclosure is a method of retail revenue based traffic optimization. The method includes determining at least one current traffic statistic at an intersection, determining that the at least one current traffic statistic contributes to at least one trend in retail revenue at one or more stores associated with the intersection and performing traffic optimization based on determining that the at least one current traffic statistic contributes to the at least one trend in retail revenue.

### CROSS-REFERENCE TO RELATED APPLICATIONS

This application claims priority to U.S. Provisional Patent Application No. 62/545,289 filed on Aug. 14, 2017, the entire content of which is incorporated herein by reference.

### FIELD OF THE DISCLOSURE

The present disclosure is generally related to navigation of vehicles, and more particularly related to the navigation of vehicles for managing revenue of nearby stores.

### BACKGROUND

Traffic control systems regulate flow of traffic at intersections. Generally, traffic signals, comprising different colors and/or shapes of lights, are mounted on poles or span wires at the intersection. These traffic signals are used to regulate the movement of traffic through the intersection by turning on and off their different signal lights. In cities, the amount of traffic is vast and thus movement in multiple directions is allowed for fast discharge of vehicles, to prevent traffic congestion.

Such traffic movements and congestion of the traffic at the intersection affect revenue of stores present around the intersection or on roads leading to such intersections. For example, entire traffic may be allowed to pass through a road to reduce the amount of traffic present at the intersection. Stores present along the road may observe an increase in revenue during such condition, while other stores present on other roads may observe reduction in revenue due to absence of traffic on the other roads. Thus, the revenues earned by such stores may be uneven and may only be dependent on routing of the traffic.

Thus, a method of effectively routing the traffic to maintain proportionate revenues made by the stores is much desired. Furthermore, this change in traffic dependent revenues may translate to fluctuations in tax revenues for cities and municipalities and the management thereof via smart traffic control infrastructures can be advantageous for such cities and municipalities.

### SUMMARY

One aspect of the present disclosure is a method of retail revenue based traffic optimization. The method includes determining at least one current traffic statistic at an intersection, determining that the at least one current traffic statistic contributes to at least one trend in retail revenue at one or more stores associated with the intersection and performing traffic optimization based on determining that the at least one current traffic statistic contributes to the at least one trend in retail revenue.

One aspect of the present disclosure is a device for retail revenue based traffic optimization. The device includes memory having computer-readable instructions stored thereon and one or more processors. The one or more processors are configured to execute the computer-readable instructions to determine at least one current traffic statistic at an intersection, determine that the at least one current traffic statistic contributes to at least one trend in retail revenue at one or more stores associated with the intersection and perform traffic optimization based on determining that the at least one current traffic statistic contributes to the at least one trend in retail revenue.

One aspect of the present disclosure includes one or more non-transitory computer-readable medium having computer-readable instructions stored thereon, which when executed by one or more processors, cause the one or more processors to determine at least one current traffic statistic at an intersection, determine that the at least one current traffic statistic contributes to at least one trend in retail revenue at one or more stores associated with the intersection and perform traffic optimization based on determining that the at least one current traffic statistic contributes to the at least one trend in retail revenue.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for controlling traffic;

FIG. 2 is a block diagram showing different components of the traffic controller of FIG. 1;

FIG. 3 is a block diagram showing different components of the light controller of FIG. 1;

FIG. 4 illustrates an example of an intersection including a nearby retail store;

FIG. 5 illustrates a flowchart of a method of determining traffic flow rates and volume executed by the traffic controller of FIG. 1;

FIG. 6 illustrates a flowchart of a method of determining correlations between traffic statistics and trends in retail revenues;

FIG. 7 illustrates an example of retail revenue data;

FIG. 8 illustrates example plots of such occurrence frequency traffic statistics (traffic attributes) and the trend;

FIG. 9 illustrates an example table of data stored in a traffic/retail revenue correlation database; and

FIG. 10 illustrates a flowchart of a method of retail revenue based traffic management.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

As noted above, using correlations between traffic flow rates at a geographical location such as an intersection and trends in retail revenue at nearby stores and merchants can provide meaningful insight and tools to both merchants as well as municipalities to not only capitalize or optimize their revenues but furthermore implement better management of traffic on nearby roads and intersections.

Throughout the present disclosure, examples and concepts will be described for determining correlations between traffic flow rates/volumes and nearby retail revenues and managing traffic based thereon.

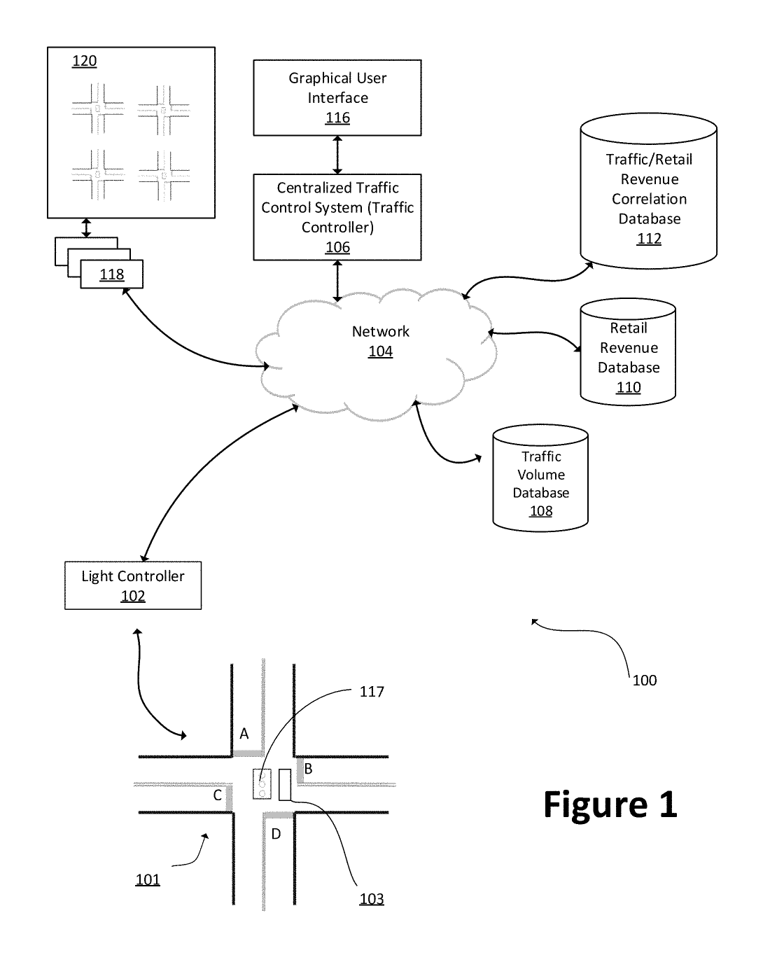

FIG. 1 illustrates a system for controlling traffic. The system 100 can comprise various components including but not limited to, a traffic light controller 102 (hereinafter may be referred to as a light controller 102) associated with a smart traffic camera 103 and a traffic light 117 installed at an intersection 101. The light controller 102 may be configured to receive traffic control rules from a traffic controller 106 and control the traffic light 117 to implement the same. The light controller 102 may or may not be physically located near (or at the same location as) the smart traffic camera 103 and/or the traffic light 117. The light controller 102, the smart traffic camera 103 and/or the traffic light 117 may be the same physical unit implementing functionalities of both. There may be more than one smart traffic camera 103 and/or traffic light 117 installed at the intersection 101.

In one example embodiment, the traffic light 117 associated with the light controller 102 can have different traffic signals directed towards all the roads/zones leading to the intersection 101. The different signals may comprise a Red light, a Yellow light, and a Green light.

The smart traffic camera 103 may be one of various types of cameras, including but not limited, to fisheye traffic cameras to detect and optimize traffic flows at the intersection 101 and/or at other intersection apart of the same local network or corridor. The smart traffic camera 103 can include any combination of cameras or optical sensors, such as but not limited to fish-eye cameras, directional cameras, infrared cameras, etc. The smart traffic camera 103 can allow for other types of sensors (e.g., audio sensors, temperature sensors, etc.) to be connected thereto (e.g., via various known or to be developed wired and/or wireless communication schemes) for additional data collection. The smart traffic camera 103 can collect video and other sensor data at the intersection 101 and convey the same to the light controller 102 for further processing, as will be described below.

The smart traffic camera 103 and/or the traffic light 117 can be used to manage and control traffic for all zones (directions) at which traffic enters and exits the intersection 101. Examples of different zones of the intersection 101 are illustrated in FIG. 1 (e.g., zones A, B, C and D). Therefore, while FIG. 1 only depicts a single smart traffic camera 103 and a single traffic light 117, there can be multiple ones of the smart traffic camera 103 and/or multiple ones of traffic lights 117 installed at the intersection 101 for managing traffic for different zones of the intersection 101.

The system 100 may further include network 104. The network 104 can enable the light controller 102 to communicate with the traffic controller 106 (a remote traffic control system 106). The network 104 can be any known or to be developed cellular, wireless access network and/or a local area network that enables communication (wired or wireless) among components of the system 100. The light controller 102 and the traffic controller 106 can communicate via the network 104 to exchange data, created traffic rules or control settings, etc., as will be described below.

The remote traffic control system 106 can be a centralized system used for managing and controlling traffic lights and conditions at multiple intersections (in a given locality, neighborhood, an entire town, city, state, etc.). The remote traffic control system 106 can also be referred to as the centralized traffic control system 106, the traffic control system 106 or simply the traffic controller 106, all of which can be used interchangeably throughout the present disclosure.

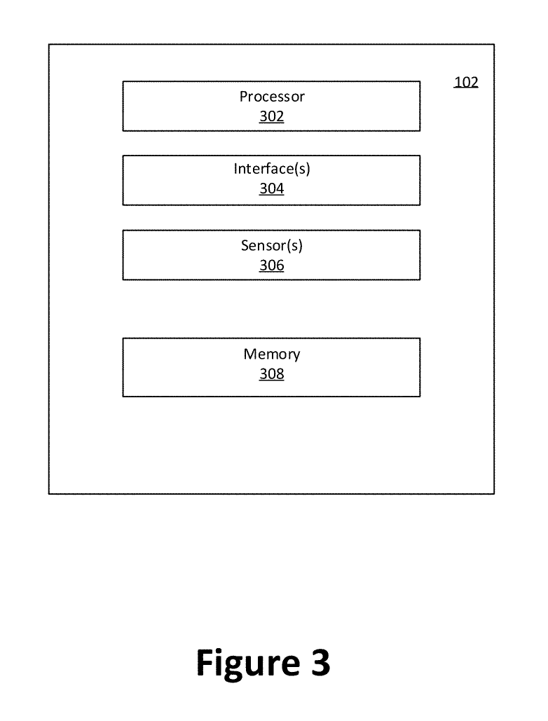

The traffic controller 106 can be communicatively coupled (e.g., via any known or to be developed wired and/or wireless network connection such as network 104) to one or more databases. One such database is a traffic volume database 108 used to store traffic flow rates and various statistics about the traffic flow at the intersection 101 based on analysis of images and data received from the smart traffic camera 103 (and/or traffic sensor(s) 306, which will be discussed below with reference to FIG. 3). Another example database is a retail revenue database 110, which may be a 3^{rd} party provided database that includes information and various statistics regarding sales and revenues of stores (e.g., brick and mortar stores) located at or near the intersection 101 or roads leading to the intersection 101. The retail revenue database 110 will be further described below. Furthermore, the retail revenue database 110 may be a public and/or private (subscription based) database accessible by the traffic controller 106. Another example database is a traffic/retail revenue correlation database 112, which can store statistics correlating various traffic flow rates and volumes to trends in retain revenue of nearby stores. The use of the traffic/retail revenue correlation database 112 will be further described below.

In one example, databases 108, 110 and 112 described above may be associated with the traffic controller 106 and may be co-located with and co-operated with traffic controller 106. Alternatively, the databases 108, 110 and 112 may be remotely located relative the traffic controller 106 and accessible via the network 104 as shown in FIG. 1.

Referring back to the traffic controller 106, the traffic controller 106 can provide a centralized platform for network operators to view and manage traffic conditions, set traffic control parameters and/or manually override any traffic control mechanisms at any given intersection. An operator can access and use the traffic controller 106 via a corresponding graphical user interface 116 after providing login credentials and authentication of the same by the traffic controller 106. The traffic controller 106 can be controlled, via the graphical user interface 116, by an operator to receive traffic control settings and parameters to apply to one or more designated intersections. The traffic controller 106 can also perform automated and adaptive control of traffic at the intersection 101 or any other associated intersection based on analysis of traffic conditions, data and statistics at a given intersection(s) using various algorithms and computer-readable programs such as known or to be developed machine learning algorithms. The components and operations of traffic controller 106 will be further described below.

Traffic controller 106 can be a cloud based component running on a public, private and/or a hybrid cloud service provided by one or more cloud service providers.

The system 100 can also have additional intersections and corresponding light controllers associated therewith. Accordingly, not only the traffic controller 106 is capable of adaptively controlling the traffic at an intersection based on traffic data at that particular intersection but it can further adapt traffic control parameters for that particular intersection based on traffic data and statistics at nearby intersections communicatively coupled to the traffic controller 106.

As shown in FIG. 1, the light controllers 118 can be associated with one or more traffic lights at one or more of the intersections 120 and can function in a similar manner as the light controller 102 and receive traffic control settings from the traffic controller 106 for managing traffic at the corresponding one of intersections 120. Alternatively, any one of the light controllers 118 can be a conventional light controller implementing pre-set traffic control settings at the corresponding traffic lights but configured to convey corresponding traffic statistics to the traffic controller 106.

The intersections 120 can be any number of intersections adjacent to the intersection 101, within the same neighborhood or city as the intersection 101, intersections in another city, etc.

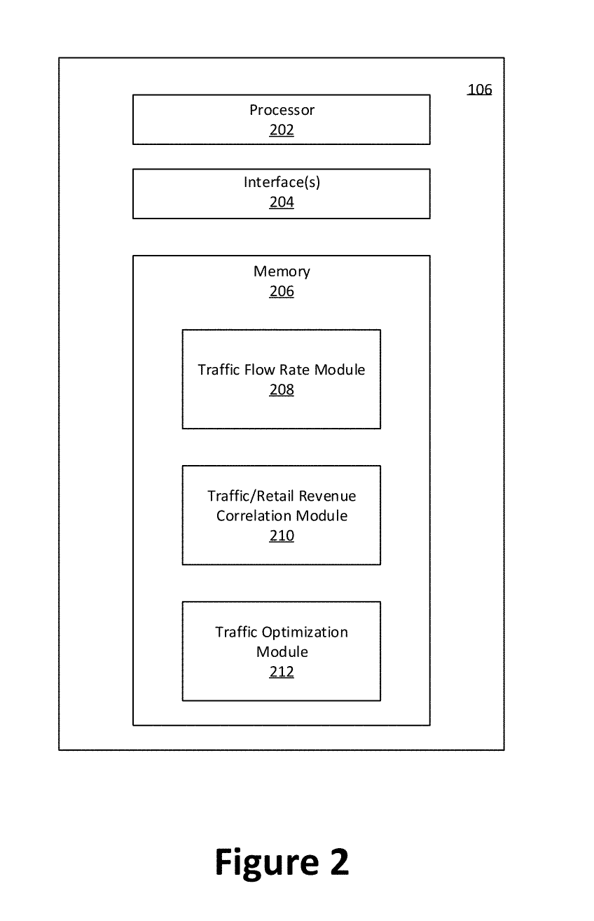

In one or more examples, the light controller 102 and the traffic controller 106 can be the same (one component implementing the functionalities of both). In such example, components of each described below with reference to FIGS. 2 and 3 may be combined into one. Furthermore, in such example, the light controller 102 may be remotely located relative to the smart traffic camera 103 and/or the traffic light 117 and be communicatively coupled thereto over a communication network such as the network 104.

As mentioned above, the components of the system 100 can communicate with one another using any known or to be developed wired and/or wireless network. For example, for wireless communication, techniques such as Visible Light Communication (VLC), Worldwide Interoperability for Microwave Access (WiMAX), Long Term Evolution (LTE), Fifth Generation (5G) Cellular, Wireless Local Area Network (WLAN), Infrared (IR) communication, Public Switched Telephone Network (PSTN), Radio waves, and other communication techniques known or to be developed in the art may be utilized.

While certain components of the system 100 are illustrated in FIG. 1, the present disclosure is not limited thereto and the system 100 may include any number of additional components necessary for operation and functionality thereof.

Having described components of an example system 100, the disclosure now turns to description of one or more examples of components of the traffic controller 106 and the light controller 102.

FIG. 2 is a block diagram showing different components of the traffic controller of FIG. 1.

The traffic controller 106 can comprise one or more processors such as a processor 202, interface(s) 204 and one or more memories such as a memory 206. The processor 202 may execute an algorithm stored in the memory 206 for managing traffic at intersections by providing recommendations and incentives to objects at the intersection to take alternative routes to their respective destinations. The processor 202 may also be configured to decode and execute any instructions received from one or more other electronic devices or server(s). The processor 202 may include one or more general purpose processors (e.g., INTEL® or Advanced Micro Devices® (AMD) microprocessors, ARM) and/or one or more special purpose processors (e.g., digital signal processors, Xilinx® System On Chip (SOC) Field Programmable Gate Array (FPGA) processor, and/or Graphics Processing Units (GPUs)). The processor 202 may be configured to execute one or more computer-readable program instructions, such as program instructions to carry out any of the functions described in this description.

The interface(s) 204 may assist an operator in interacting with the traffic controller 106. The interface(s) 204 of the traffic controller 106 can be used instead of or in addition to the graphical user interface 116 described above with reference to FIG. 1. In another example, the interface(s) 204 can be the same as the graphical user interface 116. The interface(s) 204 either accept an input from the operator or provide an output to the operator, or may perform both the actions. The interface(s) 204 may either be a Command Line Interface (CLI), Graphical User Interface (GUI), voice interface, and/or any other user interface known in the art or to be developed.

The memory 206 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 206 may include computer-readable instructions, which when executed by the processor 202 cause the traffic controller 106 to manage traffic in relation to nearby retail revenues at the intersection 101. The computer-readable instructions stored in the memory 206 can be identified as traffic flow rate module (service) 208, a traffic/retail revenue correlation module (service) 210, and a traffic optimization module (service) 212. The functionalities of each of these modules, when executed by the processor 202 will be further described below.

FIG. 3 is a block diagram showing different components of the light controller of FIG. 1. As mentioned above, the light controller 102 can be physically located near the smart traffic camera 103 and/or the traffic light 117 (e.g., at a corner of the intersection 101) or alternatively can communicate with the smart traffic camera 103 and/or the traffic light 117 wirelessly or via a wired communication scheme (be communicatively coupled thereto).

The light controller 102 can comprise one or more processors such as a processor 302, interface(s) 304, sensor(s) 306, and one or more memories such as a memory 308. The processor 302 may execute an algorithm stored in the memory 308 for implementing traffic control rules, as provided by traffic controller 106. The processor 302 may also be configured to decode and execute any instructions received from one or more other electronic devices or server(s). The processor 302 may include one or more general purpose processors (e.g., INTEL® or Advanced Micro Devices® (AMD) microprocessors, ARM) and/or one or more special purpose processors (e.g., digital signal processors, Xilinx® System On Chip (SOC) Field Programmable Gate Array (FPGA) processor, and/or Graphics Processing Units (GPUs)). The processor 302 may be configured to execute one or more computer-readable program instructions, such as program instructions to carry out any of the functions described in this description.

The interface(s) 304 may assist an operator in interacting with the light controller 102. The interface(s) 304 of the light controller 102 may be used instead of or in addition to the graphical user interface 116 described with reference to FIG. 1. In one example, the interface(s) 304 can be the same as the graphical user interface 116. The interface(s) 304 either accept an input from the operator or provide an output to the operator, or may perform both actions. The interface(s) 304 may either be a Command Line Interface (CLI), Graphical User Interface (GUI), and/or any other user interface known in the art or to be developed.

The sensor(s) 306 can be one or more smart cameras such as fish-eye cameras mentioned above or any other type of sensor/capturing device that can capture various types of data (e.g., audio/visual data) regarding activities and traffic patterns at the intersection 101. Any one such sensor 306 can be located at/attached to the light controller 102, located at/attached to the smart traffic camera 103 and/or the traffic light 117 or remotely installed and communicatively coupled to the light controller 102 and/or the smart traffic camera 103 via the network 104.

As mentioned, the sensor(s) 306 may be installed to capture objects moving across the roads. The sensor(s) 306 used may include, but are not limited to, optical sensors such as fish-eye camera mentioned above, Closed Circuit Television (CCTV) camera and Infrared camera. Further, sensor(s) 306 can include, but not limited to induction loops, Light Detection and Ranging (LIDAR), radar/microwave, weather sensors, motion sensors, audio sensors, pneumatic road tubes, magnetic sensors, piezoelectric cable, and weigh-in motion sensor, which may also be used in combination with the optical sensor(s) or alone.

The memory 308 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 308 may include computer-readable instructions, which when executed by the processor 302 cause the light controller 102 to implement traffic control rules as provided by traffic controller 106.

As mentioned above, light controller 102 and traffic controller 106 may form a single physical unit, in which case system components of each, as described with reference to FIGS. 1 to 3 may be combined into one (e.g., all example modules described above with reference to FIGS. 2 and 3 may be stored on a single memory such as the memory 206 or the memory 308).

While certain components have been shown and described with reference to FIGS. 2 and 3, the components of the light controller 102 and/or the traffic controller 106 are not limited thereto, and can include any other component for proper operations thereof including, but not limited to, a transceiver, a power source, etc.

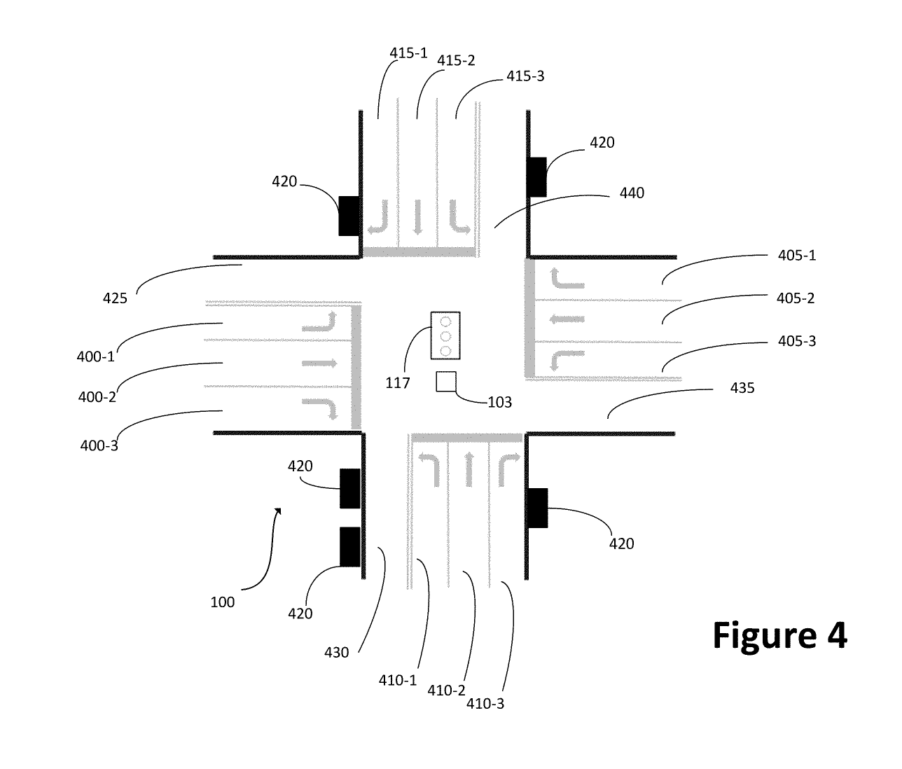

FIG. 4 illustrates an example of an intersection including a nearby retail store. As shown in FIG. 4, the intersection 101 has four entrance zones (zones 400-1 to 400-3, zones 405-1 to 405-3, zones 410-1 to 410-3 and zones 415-1 to 415-3), the traffic light 117, the smart traffic camera 103 and one or more nearby stores (merchant sites) 420. The intersection 101 of FIG. 4 also includes the light controller 102 of FIG. 1 (not shown in FIG. 4). FIG. 4 also includes an example exit zone in each direction (zones 425, 430, 435 and 440).

Having described an example system and example components of one or more elements thereof with reference to FIGS. 1-3 as well as an example of the intersection 101 with stores 420 with reference to FIG. 4, the disclosure now turns to the description of examples for managing traffic at the intersection 101 based on retail revenue.

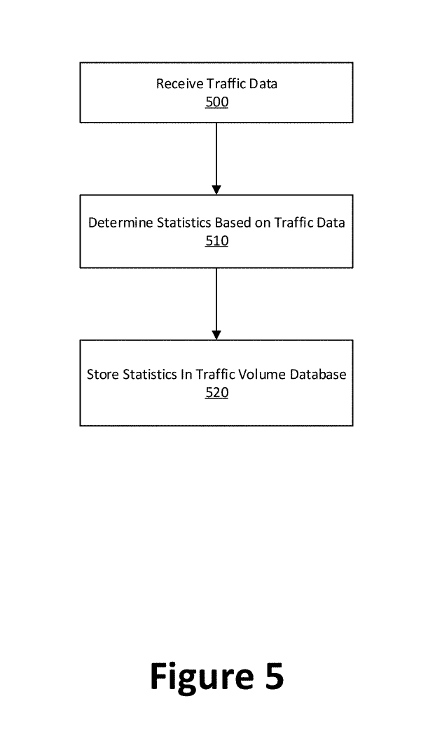

FIG. 5 illustrates a flowchart of a method of determining traffic flow rates and volume executed by the traffic controller of FIG. 1. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed example embodiments.

Furthermore, FIG. 5 will be described from the perspective of the traffic controller 106. However, it will be understood that the functionalities of the traffic controller 106 are implemented by the processor 202 executing computer-readable instructions stored on the memory 206 described with reference to FIG. 2.

At step 500, the traffic controller 106 may receive traffic data at the intersection 101. The traffic data may be collected by the smart traffic camera 103 and/or sensor(s) 306 of the light controller 102 and communicated over the network 104 to the traffic controller 106. Alternatively and when the traffic controller 106 is located at the intersection 101 (e.g., when the traffic controller 106 and the light controller 102 are the same), the traffic data collected by the smart traffic camera 103 and/or the sensor(s) 306 will be sent to the traffic controller 106 over any know or to be developed communication scheme such as the network 104 or a short range wireless communication protocol or a wired communication medium. The smart traffic camera 103 can perform the detection within the zones 400-1 to 400-3, zones 405-1 to 405-3, zones 410-1 to 410-3 and zones 415-1 to 415-3 and using any known or to be developed image/video processing methods (e.g., salient point optical flow, block matching, etc.).

In one example, the traffic data can include any type of object present at the intersection including, but not limited to, pedestrians, cars, trucks, motor cycles, bicycles, autonomous transport/moving objects and vehicles. Furthermore, cars, trucks, buses and bikes can further be broken down into sub-categories. For example, cars can be categorized into sedans, vans, SUVs, etc. Trucks can be categorized into light trucks such as pickup trucks, medium trucks such as box trucks or fire trucks, heavy duty trucks such as garbage trucks, crane movers, 18-wheelers, etc.

In one example, traffic data can also include traffic data of other adjacent and/or nearby intersections provided via corresponding smart traffic lights or light controllers such as light controllers 118 of FIG. 1.

At step 510, the traffic controller 106 can determine various traffic statistics regarding the traffic data at the intersection 101 received at step 400 by executing computer-readable instructions corresponding to the traffic flow rate module 208 stored on the memory 206 of the traffic controller 106. The traffic statistics can be determined for a plurality of time periods (e.g., time intervals of 1 minute, 2 minutes, 30 minutes, etc.). For each time period, the traffic statistics can include per-zone traffic flow rates, per-zone traffic volume (number of cars or objects detected in a zone), average traffic flow rate or volume per each entrance (and/or exit) lane(s) to and from the intersection 101, average traffic flow rate or volume per the entire intersection 101, average time spent by each object in a given zone or parked in the given zone, pedestrian traffic flow rate or volume, speed of objects detected at the intersection 101 (per-zone, average, or for the entire intersection 101), types of vehicles, etc. As noted above, the traffic controller 106 can determine the traffic statistics using known or to be developed image, video and/or data processing methods.

At step 520, the traffic controller 106 can store the traffic statistics in the traffic volume database 108. The statistics can be stored in a tabular form. For example, a table can be constructed in the traffic volume database having various entries for a number of time periods over which the traffic data at the intersection 101 is observed and the statistics described above are stored therein.

In one example, the traffic controller 106 performs the process of FIG. 5 continuously and therefore the traffic volume database 108 is constantly updated with new traffic volume data and statistics about the intersection 101 and/or any other intersection such as the intersections 120.

The data stored in the traffic volume database 108 may have an expiration date associated therewith for purposes of efficient use of computer resources for storing the traffic volume data. For example, data stored in the traffic volume database 108 may be deleted after a threshold amount of time has passed since the initial storage of the same in the traffic volume database 108 (e.g., 1 week, 1 month, 6 months, 1 year, etc.).

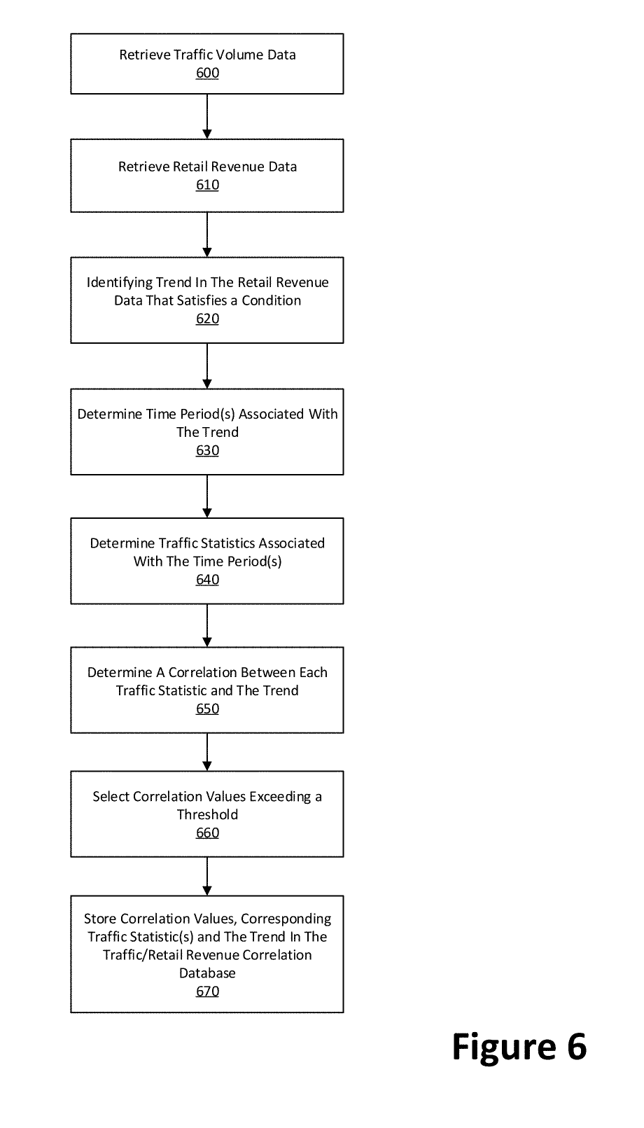

FIG. 6 illustrates a flowchart of a method of determining correlations between traffic statistics and trends in retail revenues. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed example embodiments.

Furthermore, FIG. 6 will be described from the perspective of the traffic controller 106. However, it will be understood that the functionalities of the traffic controller 106 are implemented by the processor 202 executing computer-readable instructions stored on the memory 206 described with reference to FIG. 2.

At step 600, the traffic controller 106 may receive (retrieve) traffic volume data from the traffic volume database 108 that includes various statistics about the observed traffic at the intersection 101 over periods of time.

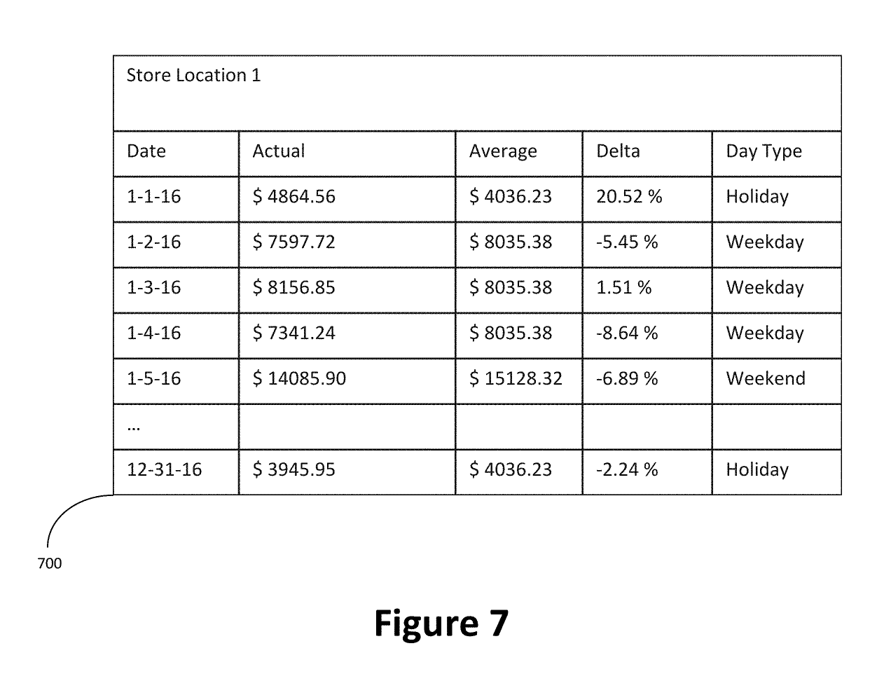

At step 610, the traffic controller 106 may receive (retrieve) retail revenue data associated with revenues of stores 420 at or near the intersection 101 from the retail revenue database 110. FIG. 7 illustrates an example of retail revenue data. Table 700 of FIG. 7 shows an example of retail revenue data for one particular store location at or near the intersection 101 (identified by location identifier “Store Location 1”). The data in table 700 may be retrieved by the traffic controller 106 from the retail revenue database 110. Table 700 can include data for multiple stores at or near the intersection 101.

Other than the location identifier, table 700 can include information on actual daily sales at the store location as well as an average sale, the type of day (e.g., weekend, holiday, week day, rainy, etc.), etc. Other information that can be included in the table 700 but is not shown includes hourly sales, weekly sales, monthly sales, annual sales, sales categorized based on product types, etc.

Returning to FIG. 6, at step 620, the traffic controller 106 may identify a trend in the retail revenue data that satisfies a condition. The condition can be a configurable parameter. For example, the condition can be a drop of 5% (relative to average sales for example) in sales or an increase of 10% (relative to average sales for example) in sales, such drop or increase thresholds can be per-product or per product category. Therefore and as an example, the traffic controller 106 may identify drops in revenue at one or more of the stores 420 at the intersection 101 that are more than 5% or increase in sales that are more than 10%.

At step 630, the traffic controller 106 can determine a time period or time period(s) over which such trend(s) has/have been identified. For example, by referencing table 700, the traffic controller 106 can identify that at store location 1, revenues dropped more than 5% during weekends but increased 10% between the hours of 6ΔM and 9ΔM every Monday.

At step 640, the traffic controller 106 can determine traffic statistics at the intersection 101 associated with the time period(s) determined at step 630. The traffic statistics stored in the traffic volume database 108 can have timestamps associate therewith showing the time periods of which such statistics are determined, observed, etc. These timestamps can also be retrieved by the traffic controller 106 at step 600.

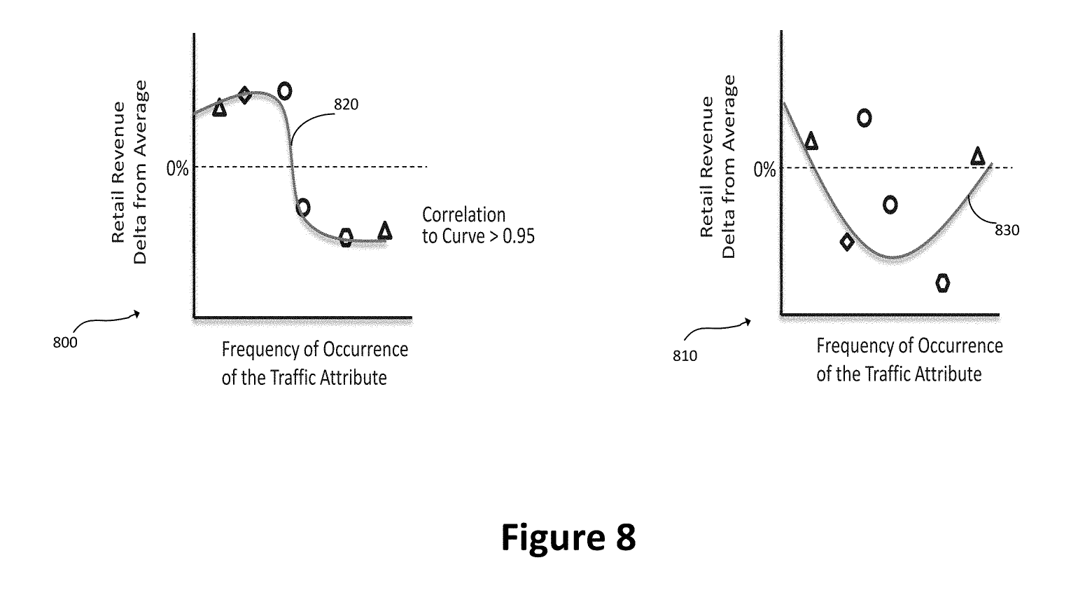

At step 650, the traffic controller 106 can use any known or to be developed method to determine a correlation between a trend and each traffic statistic over the same time period(s) by executing computer-readable instructions corresponding to the traffic/retail revenue correlation module 210 stored on the memory 206 of the traffic controller 106. For example, the trend can be that on weekdays, sales at a particular store (e.g., the store 420 shown next to the zone 410-3 in FIG. 4) increase by 10% between the hours of 6ΔM and 9ΔM. Accordingly, various traffic statistics (e.g., traffic flow rates, volume, number of stationary cars, types of objects, number of vehicles in a particular zone or lane, etc.) for the three hour period of 6ΔM to 9ΔM for each weekday that is available in the traffic volume database 108 and is retrieved at step 600 are analyzed and the correlations are determined. Furthermore, a frequency of occurrence of each traffic statistic correlated to the identified trend(s) in the retail revenues is determined. FIG. 8 illustrates example plots of such occurrence frequency traffic statistics (traffic attributes) and the trend. For example, graph 800 shows an example where a frequency of occurrence of a particular traffic statistic (e.g., number of cars in one or more lanes closes to the store(s) at which the trend is identified) is plotted against the trend in the retail revenue(s). Graph 810 illustrates another example of another traffic statistic, whose occurrence frequency is plotted against the trend.

Thereafter, a best fit curve for the relevant statistics shown in graphs 800 and 810 and the trend(s) is calculated. This curve is represented by lines 820 and 830, respectively.

At step 660, the traffic controller 106 can identify and select traffic statistics for which, based on the corresponding best fit curve, the correlation with the trend(s) is greater than a configurable threshold (e.g., greater than 60%, 90%, 95%, etc.). As can be seen from FIG. 8 and best fit curve (line) 820, the correlation of the traffic statistic of graph 800 to the trend is high (greater than 95%) whereas the best fit curve (line) 830 dearly indicates that the correlation in graph 810 is very low (less than 95% or any other configured threshold). Therefore, at step 660, the traffic controller can select the traffic statistic represented by graph 800 but not that represented by graph 810.

Thereafter, at step 670, the traffic controller 106 may store the correlation value(s) (correlation coefficient(s)), the corresponding traffic statistic(s) and the trend in the traffic/retail revenue correlation database 112.

In one example, the traffic controller 106 performs the process of FIG. 6 continuously and therefore the traffic/retail revenue correlation database 112 is constantly updated with new correlation value(s), the corresponding traffic statistic(s) and the trend(s).

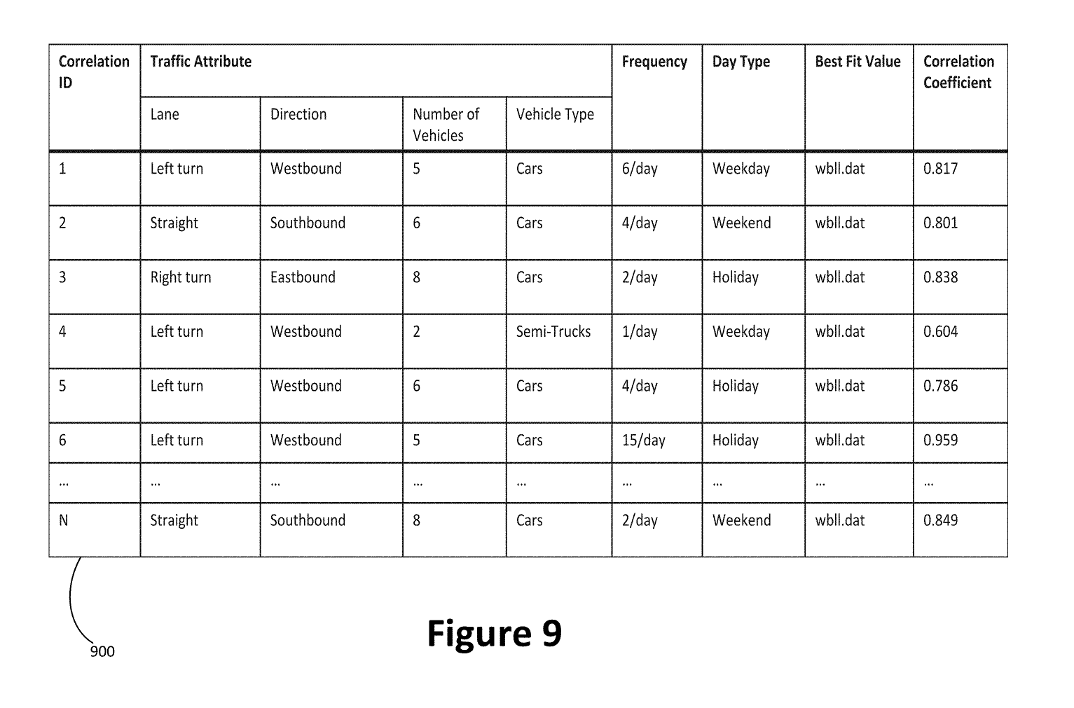

FIG. 9 illustrates an example table of data stored in a traffic/retail revenue correlation database. Table 900 (stored in the traffic/retail revenue correlation database) can include information on various traffic statistics (traffic attributes), associated occurrence frequency, associated day type, associated best fit value and associated correlation coefficients. Each entry may be stored separately with a unique correlation ID, as shown in Table 900.

While in describing FIGS. 6-9, an assumption was made that traffic statistics at the intersection 101 are taken into consideration, the present disclosure is not limited thereto and traffic conditions, statistics associated with other nearby intersections and roads (e.g., the intersections 120 of FIG. 1) may also be considered. For example, a traffic statistic for a given trend may not only include presence of 5 stationary vehicles in a particular zone at the intersection 101 but may also be attributed to higher traffic flow rates in corresponding lanes at one or more adjacent intersections 120 or a regularly scheduled public event at a location near one or more adjacent intersections 120, etc.

With a database of correlation values, the disclosure now turns to describing examples of using the correlation values to perform real time traffic controlling at the intersection 101.

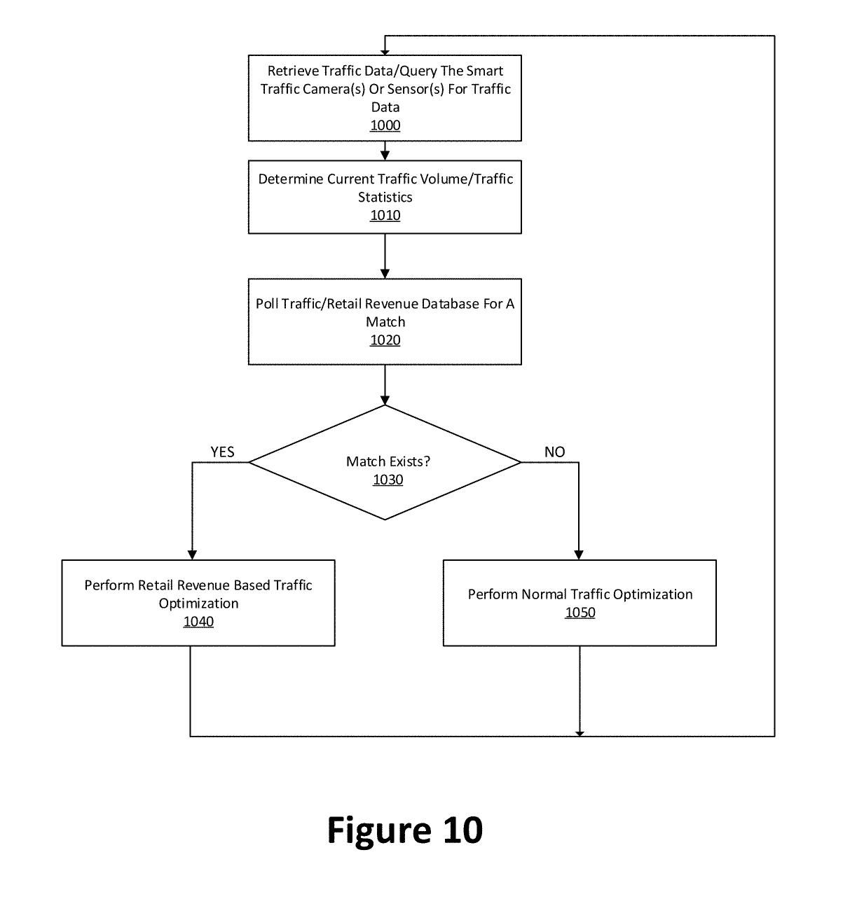

FIG. 10 illustrates a flowchart of a method of retail revenue based traffic management. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed example embodiments.

Furthermore, FIG. 10 will be described from the perspective of the traffic controller 106. However, it will be understood that the functionalities of the traffic controller 106 are implemented by the processor 202 executing computer-readable instructions stored on the memory 206 described with reference to FIG. 2. Alternatively, FIG. 10 can also be from the perspective of the light controller 102. However, it will be understood that the functionalities of the light controller 102 are implemented by the processor 302 executing computer-readable instructions stored on the memory 308 described with reference to FIG. 3.

At step 1000, the traffic controller 106 may retrieve traffic data (real-time traffic data) of the intersection 101. In one example, the traffic controller 106 may query the smart traffic camera(s) 103 and/or any other sensor(s) such as sensor(s) 306 installed at the intersection 101 for the real-time traffic data.

At step 1010, the traffic controller 106 may determine current traffic volume and current traffic statistics based on the real-time traffic data. The determination may be based on any known or to be developed image, video and data processing methods such as those used by the traffic controller 106 for generating traffic statistics to be stored in the traffic volume database 108, as described above with reference to FIG. 5.

At step 1020, the traffic controller 106 may poll the traffic/retail revenue database 112 to see if there is a match for the current traffic statistics among traffic statistics stored therein.

At step 1030, the traffic controller 106 determines if a match exists for the current traffic statistics in the traffic/retail revenue database 112. If a match exists, then at step 1040, the traffic controller 106 may perform retail revenue based traffic optimization by implementing computer-readable instructions corresponding to traffic optimization module 212 stored on memory 206 of the traffic controller 106.

In one example, the stored correlation is indicative that the current traffic statistic(s) are resulting in the associated trend (e.g., decrease in retail revenue) at one or more nearby stores 420. Therefore, the traffic controller 106 may adjust the traffic controller parameters (e.g., signals and durations thereof) in corresponding zones of the intersection 101 so as to eliminate the current traffic conditions thus prevent the decrease in retail revenue at the one or more nearby stores 420.

More specifically, assume that the current traffic statistic is 10 cars in the zone 410-3 and that there is a stored correlation between 10 or more cars in the zone 410-3 and a 5% drop in revenue at the store 420 adjacent to the zone 410-3, as shown in FIG. 4. The drop can be the result of congested road that prevents customers from stopping by to make purchases at this particular store 420. Accordingly, the traffic controller 106 can determine that the right turn signal for the zone 410-3 should be more frequent or duration thereof should be increase so as to reduce the number of cars in the zone 410-3 until the number of cars present drop below 10 cars or reach 5 cars, etc. Furthermore, as part of this retail revenue based optimization, the traffic controller 106 can communicate the change in the right turn signal to the light controller 102 for implementing the change at the traffic light(s) 117.

In another example, the trend may be an increase of 10% in sales due to the presence of 10 cars in the zone 410-3. Accordingly, the retail revenue dependent traffic optimization can include adjusting signals to maintain a presence of at least 10 cars in the zone 410-3 for a given time period (a time period in which the trend of 10% increase is detected).

Accordingly, such modification to traffic to maintain an increase in sales and revenues at the affected stores can result in higher tax revenues for the corresponding city and municipality.

In another example, the retail revenue based traffic optimization may not be solely focused on the intersection 101 but may take into consideration traffic conditions and/or trends in retail revenues at stores located near adjacent or nearby intersections such as the intersections 120.

For example, a drop in revenue at stores located near an intersection adjacent to the intersection 101 may suggest correlation to “quick changes” in signaling at the intersection 101, which allows cars to leave the intersection 101 relatively quickly and create a backup at the adjacent intersection hence resulting in the drop in the revenue of the nearby stores. Therefore, the optimization may be to increase the duration of traffic signals (or appropriate ones of the traffic signals) at the intersection 101 such that the number of cars at the adjacent intersection drops below a threshold and thus eliminate or reduce the drop in revenue at the stores located near the adjacent intersection.

Referring back to step 1030, if the traffic controller 106 determines that no match exists in the traffic/retail revenue database 112 for the current traffic statistics, then at step 1050, the traffic controller 106 may perform normal traffic optimization, according to known or to be developed methods for doing so (e.g., to increase traffic flow rates (per zone, per lane, per intersection), accommodate weather conditions, nearby scheduled events, etc.)

Thereafter, the process reverts back to step 1000.

Example embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of traffic management, the method comprising:
determining at least one current traffic statistic at an intersection;
determining that the at least one current traffic statistic contributes to at least one trend in retail revenue at one or more stores associated with the intersection; and
performing traffic optimization based on determining that the at least one current traffic statistic contributes to the at least one trend in retail revenue.

2. The method of claim 1, wherein determining that the at least one current traffic statistic contributes to at least one trend in retail revenue comprises:
querying a traffic/retail revenue database to determine if a match exists for the at least one current traffic statistic among traffic statistics stored therein; and
upon determining that the match exists, identifying the at least one trend associated with the at least one current traffic statistic, wherein
the traffic optimization is a retail revenue dependent traffic optimization such that the at least one current traffic statistic contributing to the at least one trend is one of maintained or eliminated.

3. The method of claim 2, wherein upon determining that the match does not exit, the traffic optimization is a retail revenue independent traffic optimization.

4. The method of claim 2, wherein the traffic/retail revenue database includes correlation values between a plurality of traffic statistics and a plurality of trends in retail revenues at the one or more stores.

5. The method of claim 1, wherein the at least one current traffic statistic contributes to the at least one trend if a correlation between the at least one current traffic statistic and the at least one trend is greater than a threshold.

6. The method of claim 1, wherein the retail revenue dependent traffic optimization or the retail revenue independent traffic optimization includes adjusting one or more traffic signals at the intersection.

7. The method of claim 1, further comprising:
continuously monitoring traffic conditions at the intersection;
determining traffic statistics based on the traffic conditions at the intersection; and
correlating the traffic statistics to a plurality of trends in retail revenues at the one or more stores to be used for determining whether the at least one current traffic statistic contributes to the at least one trend or not.

8. A device configured to manage traffic, the device comprising:
memory having computer-readable instructions stored therein; and
one or more processors configured to execute the computer-readable instructions to:
determine at least one current traffic statistic at an intersection;
determine that the at least one current traffic statistic contributes to at least one trend in retail revenue at one or more stores associated with the intersection; and
perform traffic optimization based on determining that the at least one current traffic statistic contributes to the at least one trend in retail revenue.

9. The device of claim 8, wherein the one or more processors are configured to execute the computer-readable instructions to determine that the at least one current traffic statistic contributes to at least one trend in retail revenue by:
querying a traffic/retail revenue database to determine if a match exists for the at least one current traffic statistic among traffic statistics stored therein; and
upon determining that the match exists, identifying the at least one trend associated with the at least one current traffic statistic, wherein
the traffic optimization is a retail revenue dependent traffic optimization such that the at least one current traffic statistic contributing to the at least one trend is one of maintained or eliminated.

10. The device of claim 9, wherein upon determining that the match does not exit, the traffic optimization is a retail revenue independent traffic optimization.

11. The device of claim 9, wherein the traffic/retail revenue database includes correlation values between a plurality of traffic statistics and a plurality of trends in retail revenues at the one or more stores.

12. The device of claim 8, wherein the at least one current traffic statistic contributes to the at least one trend if a correlation between the at least one current traffic statistic and the at least one trend is greater than a threshold.

13. The device of claim 8, wherein the device is a traffic controller communicatively coupled to a light controller, the light controller being configured to adjust one or more light settings of at least one traffic signal installed at the intersection based on the one of the retail revenue dependent traffic optimization or the retail revenue independent traffic optimization.

14. The device of claim 8, wherein the one or more processors are configured to execute the computer-readable instructions to:
continuously monitor traffic conditions at the intersection;
determine traffic statistics based on the traffic conditions at the intersection; and
correlate the traffic statistics to a plurality of trends in retail revenues at the one or more stores to be used for determining whether the at least one current traffic statistic contributes to the at least one trend or not.

15. One or more non-transitory computer-readable medium having computer-readable instructions stored thereon, which when executed by one or more processors, cause the one or more processors to:
determine at least one current traffic statistic at an intersection;
determine that the at least one current traffic statistic contributes to at least one trend in retail revenue at one or more stores associated with the intersection; and
perform traffic optimization based on determining that the at least one current traffic statistic contributes to the at least one trend in retail revenue.

16. The one or more non-transitory computer-readable medium of claim 15, wherein the execution of the computer-readable instructions by the one or more processors, cause the one or more processors to determine that the at least one current traffic statistic contributes to at least one trend in retail revenue by:
querying a traffic/retail revenue database to determine if a match exists for the at least one current traffic statistic among traffic statistics stored therein; and
upon determining that the match exists, identifying the at least one trend associated with the at least one current traffic statistic, wherein
the traffic optimization is a retail revenue dependent traffic optimization such that the at least one current traffic statistic contributing to the at least one trend is one of maintained or eliminated.

17. The one or more non-transitory computer-readable medium of claim 16, wherein upon determining that the match does not exit, the traffic optimization is a retail revenue independent traffic optimization.

18. The one or more non-transitory computer-readable medium of claim 16, the traffic/retail revenue database includes correlation values between a plurality of traffic statistics and a plurality of trends in retail revenues at the one or more stores.

19. The one or more non-transitory computer-readable medium of claim 15, wherein the at least one current traffic statistic contributes to the at least one trend if a correlation between the at least one current traffic statistic and the at least one trend is greater than a threshold.

20. The one or more non-transitory computer-readable medium of claim 15, wherein the execution of the computer-readable instructions by the one or more processors, cause the one or more processors to:
continuously monitor traffic conditions at the intersection;
determine traffic statistics based on the traffic conditions at the intersection; and
correlate the traffic statistics to a plurality of trends in retail revenues at the one or more stores to be used for determining whether the at least one current traffic statistic contributes to the at least one trend or not.
